(19) United States
(12) Patent Application Publication
(10) Pub. No.: US 2008/0029521 A1
(43) Pub. Date: Feb. 7, 2008

(54) Ultimate expandable cookware

(76) Inventor: Tracey J Bouwman, Fennville, MI (US)

Correspondence Address: Tracey J Bouwman, 2500 54th Street, Fennville, MI, 49408, US

(21) Appl. No.: 11/499,523

(22) Filed: Aug. 7, 2006

(51) Int. Cl. A47J 37/01

(52) U.S. Cl. 220/573.1

(57) ABSTRACT

A base 3 which has wall inclosing device 4 which has an extruded edge 2 by the extruded edge 2 is the locking mechanism 1.

### CROSS-REFERENCE TO RELATED APPLICATIONS

This application relates to and claims priority from U.S. Provisional Patent Application Ser. No. US60/68413 13 filed on May 26, 2005, specifications which are incorporated herein by reference.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to a cookware vessel for the camping industry which will expand and contract allowing the user easy storage and transport.

### BACKGROUND OF INVENTION

In the past people would load all their cooking gear which would include but not limited to flat fry pans and kettles and or various cooking gear for preparing food while away from home, such as camping. A typical camper will load up his gear which would include many pieces of cooking gear for preparation of food. The problem arises when campers have limited space to transport all of the various pieces of cookware. Not only is the space resuaints an issue but the time factor does come into play. To remove cooking gear from house or shed or storage does take time.

(a) The problem of time restraints when locating and relocating all the cookware needed to cook food while away from a regular kitchen.

(b) The problem of space restraints Patent Application of Tracey Bouwman for

(c) Valuable resources like steel is being over used to manufacture many different sizes of cookware.

### BACKGROUND OF INVENTION—OBJECTS AND ADVANTAGES

Accordingly, beside the objects and advantages of the current cookware described in my above patent, several objects and advantages of the present invention are:

(a) With my new cookware time restraints will greatly decrease, there will be no need to unload and load many different sizes of pans.

(b) With my new cookware space restraints will greatly decrease because you will not have many different sizes of cookware you will have one.

(c) With my new cookware valuable resources will not be need to make all different sizes of pans because you will have all universal sizes.

Further objects and advantages are to provide a way of reducing time restrains, space restraints as well as reducing the un warranted use of our resources. To add with this new cookware the process of cooking outside of a home kitchen will be much easier. Still further objects and advantages will become abundantly clear with the description and drawings.

### SUMMARY

In accordance with the present invention the “Ultimate Expandable Cookware” comprises of a round bottom with sides which have interlocking rings with a locking mechanism on the interlocking rings.

### DRAWINGS—FIGURES

FIG. 1 depicts a top view of the Ultimate Expandable Cookware. FIG. 1 (1) depicts the locking mechanism. FIG. 1 (2) depicts the top of the rings with an extruded edge. FIG. 1 (3) depicts the base.

FIG. 2 depicts a side view of the Ultimate Expandable Cookware. FIG. 2 (1) depicts the locking mechanism. FIG. 2 (2) depicts the top of the rings with an extruded edge. (3) depicts the base.

### DRAWINGS—REFERENCE NUMERALS

1 locking mechanism

2 extruded edge

3 base

4 Wall inclosing device

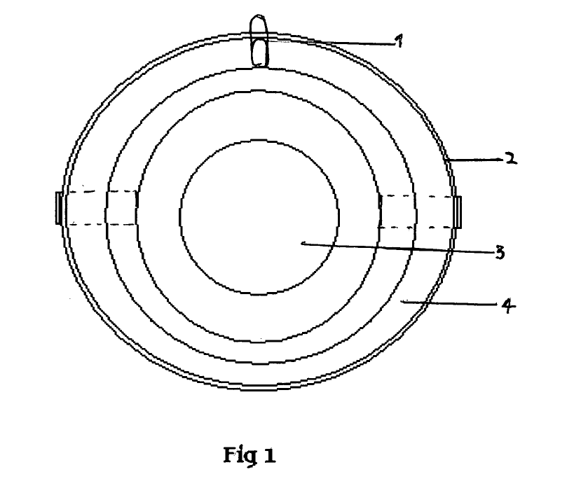

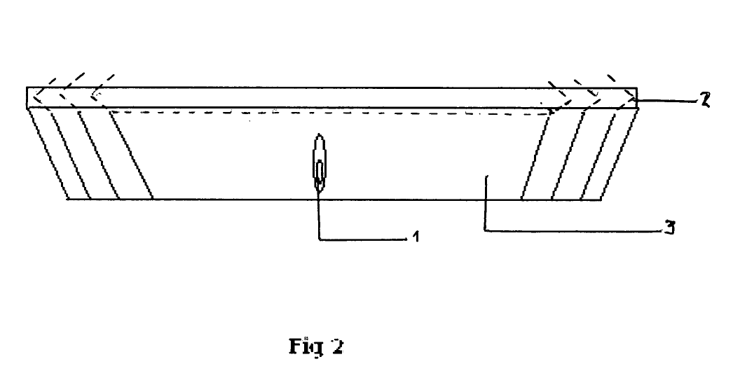

### DETAILED DESCRIPTION—FIGS. 1 AND 2 PREFERRED EMBODIMENTS

A preferred embodiment of the present invention is illustrated in FIG. 1 top view and FIG. 2 side view. The embodiment has wall inclosing device1 (4) adhered to FIG. 1(3) base. The embodiment has all inclosing device 1 (4) with a locking mechanism FIG. 1(1). The embodiment has rings with an extruded edge FIG. 1 (2). The embodiment has adhered wall inclosing device2 (4) to FIG. 2 (3) base. The embodiment has wall inclosing device 2 (4) with a locking mechanism FIG. 2(1). The embodiment has all inclosing device 2 (4) with an extruded edge FIG. 2 (2).

### Operations—FIGS. 1 and 2

The manner of utilizing the Ultimate Expandable cookware is to expand wall enclosing device 1(4) and 2 (4) which will allow the cookware to expand and become a larger vessel. After which, the locking mechanism 1(1) and 2 (1) will be engaged. This will allow for the Ultimate Expandable Cookware to lock the wall inclosing mechanism 1(4) and 2 (4) to the base 1(3) and 2(3). The extruded edge 1(2) and 2 (2) will create a seal which in turn will stop liquids from escaping from the wall inclosing mechanism 1(4) and 2 (4).

From the description above, a number of advantages of my Ultimate Expandable Cookware will become Evident.

(a) Less space will be needed when cooking outside the normal atmosphere kitchen.

(b) Less time will be needed in loading and unloading cookware.

(c) With this product less materials will be needed because this pan will take the place the need to have various sizes of pans.

(d) with this product less space is needed in the home kitchen.

### Conclusion, Ramifications and Scope

Accordingly the reader will see the Ultimate Expandable cookware will allow for less space needed to stow pots and pans. The reader will also conclude with Ultimate Expandable cookware less time will be need for loading and unloading pans when leaving the comfort of the home. To add, the reader will see with this product the need for many different sizes of pans will diminish greatly, which in turn will decrease the amount of steel need to manufacture many different sizes of pans and or kettles.

Thus the scope of the invention should be decided by the appended claims and their legal equivalents , rather then by examples given.

We claim:

1. A cookware vessel of any shape or size which will expand to an unvarying size.
(i) Locking Mechanism
(ii) Extruded edge
(iii) Base
(iv) Wall inclosing device
